(19) United States
(12) Patent Application Publication
(10) Pub. No.: US 2023/0150183 A1
(43) Pub. Date: May 18, 2023

(54) CONTAINER AND METHOD OF MANUFACTURE

(71) Applicant: Ring Container Technologies, LLC, Oakland, TN (US)

(72) Inventors: Matthew James Danhof, Knoxville, TN (US); Scott James Glassbrook, Howell, MI (US); Jason Raymond Paris, San Bernardino, CA (US)

(73) Assignee: Ring Container Technologies, LLC, Oakland, TN (US)

(21) Appl. No.: 17/527,530

(22) Filed: Nov. 16, 2021

(51) Int. Cl. B29C 49/42; B29C 49/06; B65D 1/02; B65D 41/34

(52) U.S. Cl. CPC B29C 49/4273; B29C 49/06; B65D 1/0207; B65D 1/0246; B65D 1/0276; B65D 41/34; B29K 2067/003

(57) ABSTRACT

A blow molded container is provided. The container includes a neck including a sealing surface and a neck finish. The sealing surface defines at least one vent. In some embodiments, methods of manufacturing containers are disclosed.

### TECHNICAL FIELD

The present disclosure generally relates to blow-molded containers and more particularly to plastic containers capable of high fill temperatures and pasteurization, and methods for making the same for food packaging.

### BACKGROUND

Plastic blow-molded containers are commonly used for food packaging products. Many food and beverage products are sold to the consuming public in blow-molded containers. These containers can be made from polyethylene terephythalate or other suitable plastic resins in a range of sizes. The empty blow-molded containers can be filled with food and/or beverage products at a fill site utilizing automated fill equipment.

For example, manufacture of such plastic blow-molded containers can include initially forming plastic resin into a preform, which may be provided by injection molding. Typically, the preform includes a mouth and a generally tubular body that terminates in a closed end. Prior to being formed into containers, preforms are softened and transferred into a mold cavity configured in the shape of a selected container. In the mold cavity, the preforms are blow-molded or stretch blow-molded and expanded into the selected container.

These food packaging containers are adapted to store food packaging products, however, during manufacturing and depending on the type of food being store in the container, the container may need to be breathable. This disclosure describes an improvement over these prior technologies.

### SUMMARY

In one embodiment, a blow molded container is provided. The container includes a neck including a sealing surface and a neck finish. The sealing surface defines at least one vent. In some embodiments, container systems and methods of manufacturing containers are disclosed.

In one embodiment, the blow molded container includes a neck including a circumferential lip extending from an opening of the neck and being configured to sealing engage a closure. The neck includes a neck finish having at least one gap. The container includes a body defining a volume and having a base. The lip defines at least one vent aligned with the at least one gap in a configuration for passage of a gas from the volume.

In one embodiment, a method for manufacturing a blow molded container is provided. The method comprising the steps of: blow molding a preform having a selected configuration into an intermediate article having a neck and a dome, the neck including a sealing surface having at least one recess and a neck finish; cutting the sealing surface to define an articulating element including the at least one recess; and trimming the intermediate article to remove the dome and the element in a configuration to form a finished container including the sealing surface having at least one vent.

### BRIEF DESCRIPTION OF THE DRAWINGS

The present disclosure will become more readily apparent from the specific description accompanied by the following drawings, in which:

FIG. 1 is a perspective view of one embodiment of a container in accordance with the principles of the present disclosure;

FIG. 2 is a top view of components of the container shown in FIG. 1;

FIG. 3 is an enlarged perspective view of components of the container shown in FIG. 1;

FIG. 4 is an enlarged perspective view of components of the container shown in FIG. 1;

FIG. 5 is an enlarged perspective view of components of the container shown in FIG. 1;

FIG. 6 is an enlarged perspective view of one embodiment of a container in accordance with the principles of the present disclosure;

FIG. 7 is a flowchart illustrating the steps of a method of making a container in accordance with the principles of the present disclosure;

FIG. 8 is a front view of one embodiment of a container in accordance with the principles of the present disclosure;

FIG. 9 is an enlarged perspective view of the container shown in FIG. 8; and

FIG. 10 is a perspective view of one embodiment of a device for use with a method of making the container in accordance with the principles of the present disclosure.

### DETAILED DESCRIPTION

The exemplary embodiments of blow-molded containers and more particularly, polyethylene terephythalate (PET) containers and methods for making the same are discussed in terms of food packaging products. In some embodiments, the present container includes a blown-neck finish closure with a molded sealing surface vent for products that require a breathable container.

In some embodiments, the present container has a recess, including a sealing surface vent configured to facilitate gas release from within a sealed container. In some embodiments, the sealing surface vent is molded and trimmed on a two stage blown finish container. In some embodiments, the container is formed from plastic. In some embodiments, the container is vented at the closure. In some embodiments, during manufacture, the amount of plastic employed for manufacture is reduced relative to standard vented injected finishes without a reduction in performance of the container.

In some embodiments, the present container includes a sealing surface vent. In some embodiments, the container includes one or a plurality of sealing surface vents. In some embodiments, the sealing surface vent can include variously configured shapes and/or sizes. In some embodiments, the variously configured shapes and/or sizes include semi-circular and/or sawtooth. In some embodiments, the container includes tamper evidence features and the sealing surface vent includes a sawtooth shape configuration. In some embodiments, the sealing surface vent includes a selected surface area.

In some embodiments, a method for manufacturing the present container is provided. In some embodiments, the method includes the step of blow molding an intermediate container. In some embodiments, the method incudes the step of transferring the intermediate container into a punch trimmer. In some embodiments, the method includes the step of positioning clamping jaws of the punch trimmer in a closed orientation to secure a neck and/or one threads of the intermediate container. In some embodiments, the method includes the step of inserting pneumatic cylinders to insert punches into the intermediate container to form the sealing surface vent. In some embodiments, the punch trimmer includes the pneumatic cylinders. In some embodiments, the method includes the step of retracting the punches via the pneumatic cylinders from the intermediate container. In some embodiments, the method includes the step of positioning the clamping jaws of the punch trimmer in an open position to release the intermediate container onto a conveyer. In some embodiments, the method includes the step of passing the intermediate container through a trimmer where a punched flap and a dome of the intermediate container is removed to form a finished container.

In some embodiments, the present manufacturing method described above includes a container mold, for example, a bottle mold. In some embodiments, the mold includes a recess or a plurality of recesses in the sealing surface of the mold. In some embodiments, the recess or plurality of recesses are oriented to not impede release of the intermediate container from the mold. In some embodiments, the recess or plurality of recesses are oriented in a T-90 direction perpendicular to a parting line of the mold. In some embodiments, the mold includes a dome disposed above the sealing surface. In some embodiments, the dome includes a relief where a vent or a plurality of vents can be punched and/or cut out above the relief in the sealing surface post mold. In some embodiments, the mold includes a snap ring or bead disposed around the neck of the mold. In some embodiments, the snap ring or bead includes reliefs and/or interruptions such that gas can escape easily from the plurality of sealing surface vents of a finished container. In some embodiments, the mold includes threads configured for engagement with a cap. In some embodiments, the threads include reliefs and/or interruptions. In some embodiments, the interruption includes a gap.

In some embodiments, the present manufacturing method includes a punch trimmer configured to form the sealing surface vent within the intermediate container post-molding. In some embodiments, the punch trimmer is configured to cut the vent in a flush configuration with the sealing surface. In some embodiments, the punch trimmer includes clamping jaws. In some embodiments, the clamping jaws are positioned in an open and/or closed orientation. In some embodiments, the clamping jaws include pneumatic punches. In some embodiments, a pneumatic punch is disposed on an inside of each of the jaws. In some embodiments, the clamping jaws are employed to secure the finish of the neck of the intermediate container while the pneumatic punches are inserted into molded recessed locations. In some embodiments, the pneumatic punches are rapidly inserted into the molded recessed locations to form vents. In some embodiments, the clamping jaws are positioned in the open and closed orientation via a programmable logic controller controlled punching machine. In some embodiments, the programmable logic controller receives inputs from a blow molder programmable logic controller and/or receives inputs from one or more sensor inputs. In some embodiments, the punching process is controlled by the programmable logic controller. In some embodiments, the machine controls pneumatic or servo-driven opening and closing of the clamping jaws. In some embodiments, the machine controls pneumatic insertion and retraction of the pneumatic punches.

In some embodiments, the present manufacturing method includes pneumatic punches that cut vents into the sealing surface. In some embodiments, the pneumatic punches cut the vent vertically into the dome on one or more sides of a relief. In some embodiments, the pneumatic punches are inserted into the intermediate container to produce a U-shaped cut. In some embodiments, a plurality of U-shaped cuts are produced. In some embodiments, a top of a U-shaped cut is left uncut and is creased/hinged inwardly by the pneumatic punches. In some embodiments, after the punching process is complete, the punch trimmer is retracted and the clamping jaws securing the neck finish of the intermediate container are positioned in the open orientation to allow the intermediate container to continue to a trimmer device where the dome is removed along with the top of the U-shaped cut that is hinged. In some embodiments, a finished container includes a sealing surface that is on a single plane and a vent that is disposed on a different plane. In some embodiments, the sealing surface vent is recessed within the sealing surface. In some embodiments, the punching process is configured for use with various types of plastic containers produced with a blown neck finish. In some embodiments, the punching process can be employed to produce various types of vent configurations along the sealing surface of a blown finish container.

In some embodiments, the present manufacturing method includes a punching process performed inside of a mold cavity. In some embodiments, a dome relief is cut inside of the mold while the mold is under pressure. In some embodiments, the punching process is a post-mold punching process. In some embodiments, the post-mold punching process is completed after the dome of an intermediate container is removed. In some embodiments, the dome is removed via a male-female punch set. In some embodiments, operating speeds of the punching process varies depending on the rate of production and operates as quickly as needed to form a clean cut without burrs or rough edges.

In some embodiments, the present manufacturing method includes a sealing surface vent and/or dome relief that can have variously configured shapes and/or sizes. In some embodiments, the variously configured shapes include semi-circular and/or sawtooth. In some embodiments, the container includes tamper evidence features and the sealing surface vent includes a sawtooth shape configuration. In some embodiments, the sealing surface vent includes a surface area.

In some embodiments, the present manufacturing method includes the step of machining a mold and/or insert to form an intermediate container that includes a recess or recesses disposed within the sealing surface, a dome relief or reliefs, a thread or threads disposed at a neck including an interruption, and/or a snap ring/bead that includes an interruption. In some embodiments, the present manufacturing method includes the step of operating the clamping jaws via mounting the clamping jaws to a machine frame sub-assembly that is opened and closed via pneumatics, servo or other mechanical devices. In some embodiments, punches of the clamping jaws are mounted to fixed air cylinders such that the punches can extend into the intermediate container and then fully retract. In some embodiments, a sub-assembly is provided that positions the clamping jaws in an open and closed orientation and is mounted to a base frame that includes a programmable logic controller, one or more valves, manual controls, and/or a safety circuit.

In some embodiments, the present manufacturing method includes the step of operating a blow molder to produce the intermediate container. In some embodiments, the present manufacturing method includes the step of automatically conveying the intermediate container into a punching machine where a fully automatic punching process occurs. In some embodiments, the method incudes the step of inserting the intermediate containers into a trimmer. In some embodiments, the trimmer removes a punched flap and a dome flash of the intermediate container. In some embodiments, the present manufacturing method includes a finished container including a sealing surface vent. In some embodiments, the present manufacturing method includes a finished container including a plurality of sealing surface vents.

In some embodiments, the present manufacturing method includes an operating temperature of the preform at 115 degrees Celsius to about 125 degrees Celsius and a blow mold temperature at 130 degrees Celsius to about 140 degrees Celsius. In some embodiments, a sidewall of the present container includes a PET percent crystallinity of 23% to about 32%. In some embodiments, the present container can maintain an initial shape at an elevated pressure of greater than 3 pounds per square inch (psi) and an elevated vacuum of greater than 3 inches of mercury (In Hg).

In some embodiments, the present manufacturing method fabricates the present container via an injection molded preform, which is subjected to a blow mold and trim process. In some embodiments, the present container can be filled with food, food preparation oils, viscous and/or beverage products. In some embodiments, the container is used for storing food including pretzels and/or cheeseballs. In some embodiments, the present container can be employed as a cold fill container. In some embodiments, the present container can be employed as a hot fill container.

In some embodiments, the present disclosure includes a container that is employed with a method for manufacturing food packaging having the ability to produce food packages made from PET with minimal weight and selectively desirable physical performance features, as described herein.

In some embodiments, the present container is manufactured with selective physical performance features, for example, a reduction in plastic weight, a selected pre-form design, selected bottle processing and/or bottle crystallinity of a circumferential side wall of a blown container of the present container. In some embodiments, the selected physical performance features can include a higher injection molding efficiency and/or cavitation and an increased bi-axial orientation of PET container material. In some embodiments, the present container is manufactured with a smaller diameter preform, which forms a final bottle neck finish through the blowing process that allows for higher injection mold efficiency as well as improved material orientation throughout the container. In some embodiments, the container includes a container with an improved material distribution and crystalline orientation. In some embodiments, the manufacturing method provides a container having improved top load, vacuum resistance and/or permeability. In some embodiments, the manufacturing method provides stretching PET to optimum crystalline orientation levels to improve physical performance in top load, vacuum, gas and vapor permeation through the container side wall.

In some embodiments, the present manufacturing method provides PET enhancements via improved material orientation with selective physical performance features, such as, for example, improved top load performance and/or improved moisture vapor transmission rate (MVTR) performance.

The present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. In some embodiments, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

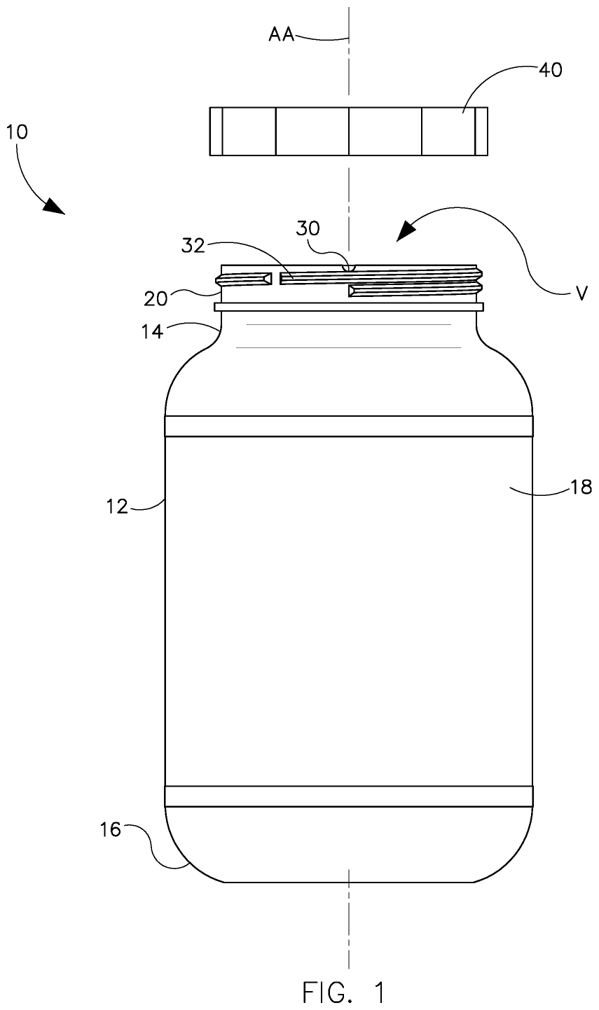

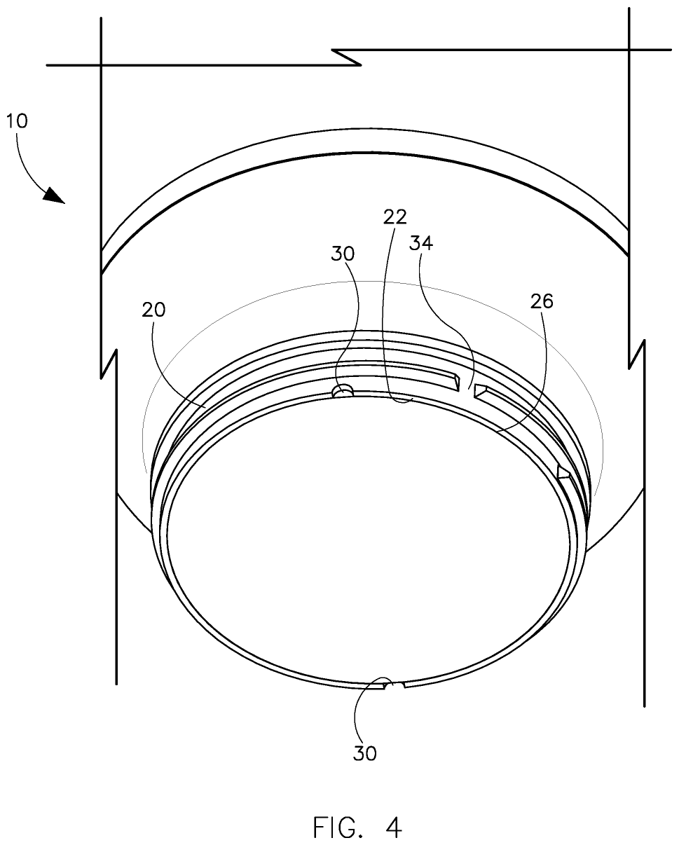

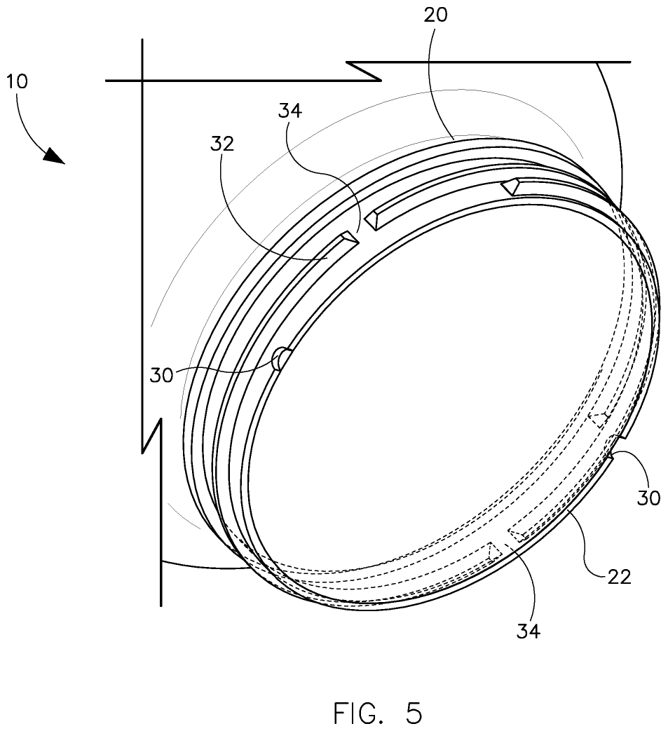

The following discussion includes a description of components of a blow molded container. Alternate embodiments are also disclosed. Reference is made in detail to the exemplary embodiments of the present disclosure, which are illustrated in the accompanying figures. Turning to FIGS. 1-6, there are illustrated components of a blow molded container 10.

Container 10 is configured for storing products such as food, food preparation and/or beverages. Container 10 includes a body 12 that extends from an end 14 to an end 16, and defines a longitudinal axis AA, as shown in FIG. 1. Body 12 includes a circumferential side wall 18 that extends between ends 14, 16. A volume V is defined from body 12, as shown in FIG. 1. Body 12 includes a substantially cylindrical configuration. In some embodiments, body 12 may include various configurations, such as, for example, oval, oblong triangular, square, polygonal, irregular, uniform, non-uniform, offset, staggered, and/or tapered. Body 12 may be manufactured by blow molding techniques, as described herein. In some embodiments, body 12 includes one or a plurality of walls.

End 14 includes a surface that defines a neck 20, as shown in FIGS. 1 and 3-5. Neck 20 is centrally disposed relative to body 12 and includes a cylindrical neck configuration. In some embodiments, neck 20 may include various configurations, such as, for example, oval, oblong triangular, square, polygonal, irregular, uniform, non-uniform, offset, staggered, and/or tapered. In some embodiments, neck 20 can include various surface configurations including smooth, rough, textured, porous, semi-porous, dimpled, knurled, toothed, raised, grooved and/or polished.

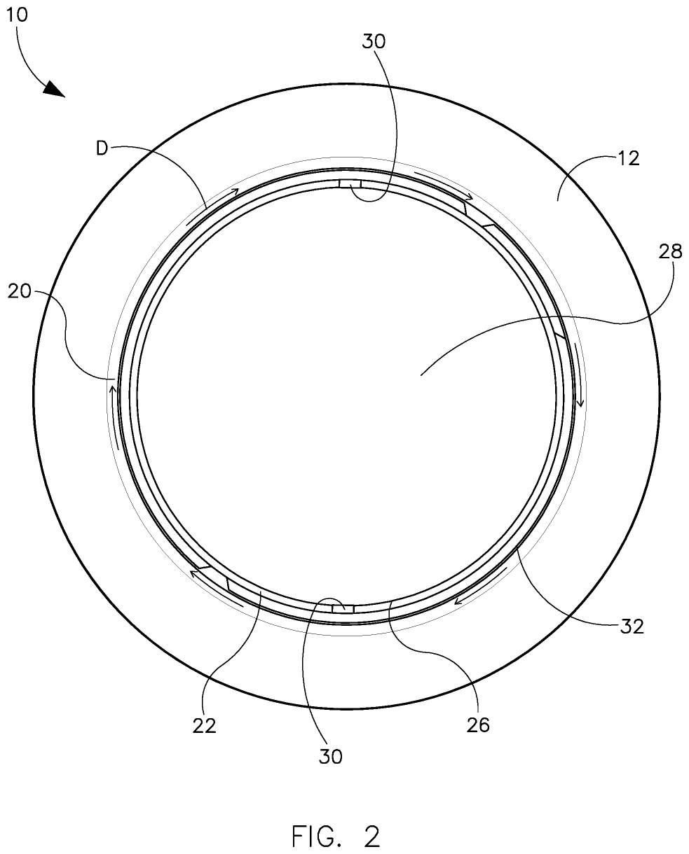

Neck 20 includes a sealing surface 22 and a neck finish 24, as shown in FIGS. 2-4. Sealing surface 22 includes a circumferential lip 26 extending from an opening 28 of neck 20. Sealing surface 22 is configured for sealing engagement with a closure, as described herein. In some embodiments, sealing surface 22 can include various surface configurations including smooth, rough, textured, porous, semi-porous, dimpled, knurled, toothed, raised, grooved and/or polished.

Sealing surface 22 defines a recess, for example, a vent 30, as shown in FIGS. 2-5. Vent 30 is disposed about circumferential lip 26 and is configured for passage of a gas, for example, pressurized gas from volume V. The pressurized gas exits through vent 30 from inside of container 10 when container 10 is sealed via a closure, for example, a lid 40. In some embodiments, the pressurized gas passes through spaced apart portions, including a gap 34 in a thread 32, described herein, and releases into atmosphere external to container 10. In some embodiments, the pressurized gas rotates around thread 32 and releases into the atmosphere.

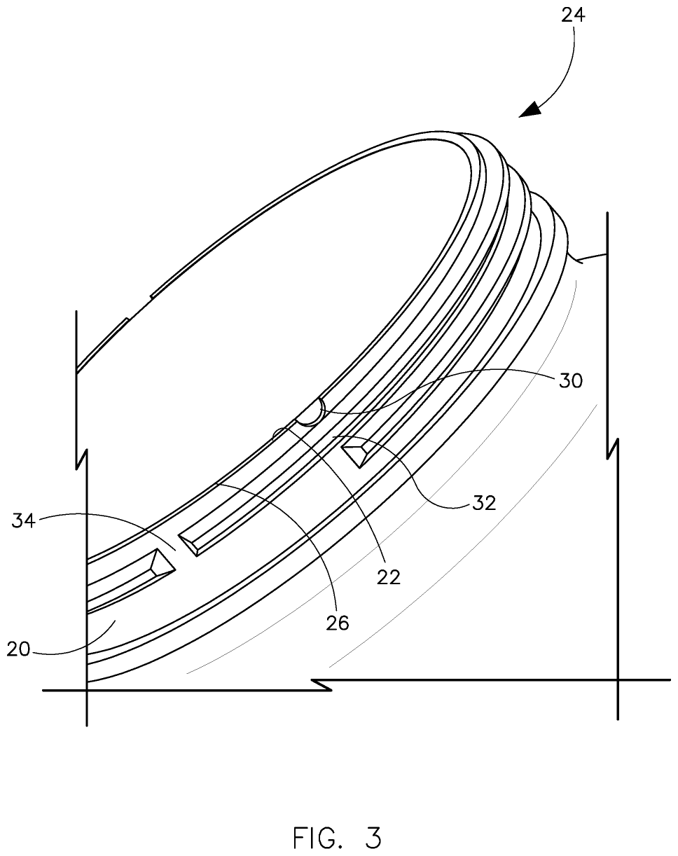

Vent 30 includes a wall that includes a continuous surface extending between a surface of neck 20 and sealing surface 22, as shown in FIG. 3. Vent 30 is continuous and non-interrupted with openings. In some embodiments, vent 30 may include one or more through openings. Vent 30 is axially aligned relative to sealing surface 22 and body 12, as shown in FIG. 3. In some embodiments, vent 30 may be disposed at alternate orientations, relative to sealing surface 22, for example, parallel, transverse and/or angular orientations such as acute or obtuse, coaxial and/or may be offset or staggered. Vent 30 includes a recessed, semi-circular configuration, as shown in FIG. 3. In some embodiments, vent 30 includes a saw-tooth configuration to provide tamper evidence. In some embodiments, vent 30 may include various configurations, such as, for example, oval, oblong triangular, square, polygonal, irregular, uniform, non-uniform, offset, staggered, and/or tapered.

In some embodiments, sealing surface 22 includes a plurality of vents 30. In some embodiments, the plurality of vents 30 are variously dimensioned and include, but are not limited to a length from about 1 mm to about 10 mm, a height from about 1 mm to about 10 mm and/or a depth from about 1 mm to about 10 mm.

Vent 30 includes a selected surface area. In some embodiments, the surface area is 1 to 500 mm². In some embodiments, sealing surface 22 includes a plurality of vents 30 having the same or different surface area. In some embodiments, each vent 30 has the same or different surface area depending on the dimensions of each vent 30.

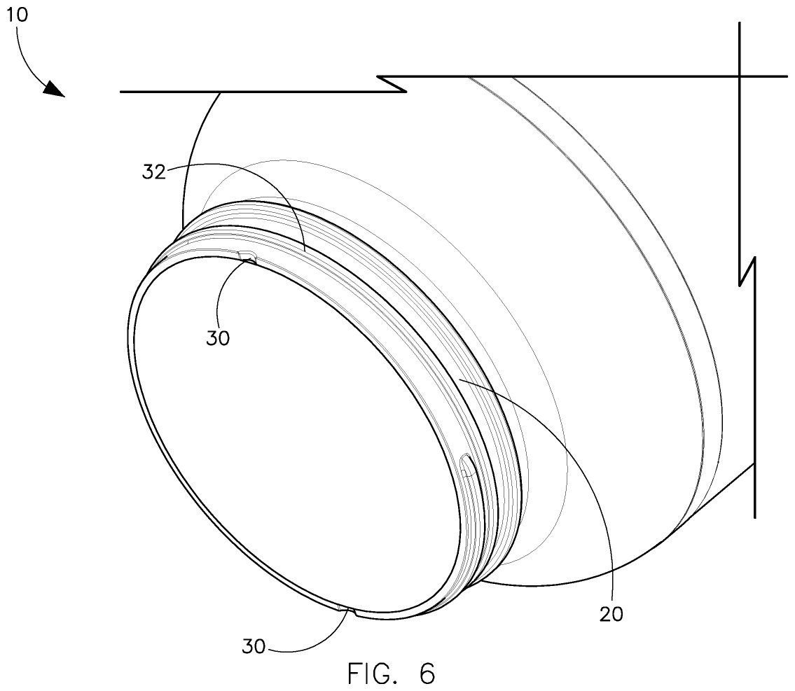

Neck finish 24 includes a diameter D, as shown in FIG. 2 and thread 32 is disposed about diameter D. Thread 32 is configured for engagement with lid 40. In some embodiments, thread 32 includes at least one thread. In some embodiments, thread 32 includes a plurality of threads 32. In some embodiments, thread 32 may include various configurations, such as, for example, non-angled, irregular, uniform, non-uniform, offset, staggered, and/or tapered. Thread 32 includes a discontinuous thread, as shown in FIG. 3. As described above, thread 32 includes gap 34, as shown in FIGS. 3-5. Vent 30 is configured for alignment with gap 34 in a configuration for passage of pressurized gas from volume V, as described herein. In some embodiments, all or a portion of gap 34 can be aligned with vent 30. In some embodiments, thread 32 includes a plurality of gaps 34. In some embodiments, thread 32 is continuous and does not include gap 34, as shown in FIG. 6.

In some embodiments, container 10 includes a snap bead (not shown). The snap bead is configured for snap engagement with lid 40. In some embodiments, the snap bead is an interrupted ring. In some embodiments, the snap bead may include various configurations, such as, for example, non-angled, irregular, uniform, non-uniform, offset, staggered, and/or tapered. In some embodiments, lid 40 is metal and/or plastic.

Container 10 is made from PET. In some embodiments, container 10 may be fabricated from plastic. In some embodiments, container 10 may be fabricated from polyester (PES), polyethylene (PE), high-density polyethylene (HDPE), polyvinyl chloride (PVC), polyvinylidene chloride (PVDC) (Saran), low-density polyethylene (LDPE), polypropylene (PP), polystyrene (PS), high impact polystyrene (HIPS), polyamides (PA) (Nylons), acrylonitrile butadiene styrene (ABS), polyethylene/acrylonitrile butadiene styrene (PE/ABS), polycarbonate (PC), polycarbonate/acrylonitrile butadiene styrene (PC/ABS), and/or polyurethanes (PU). In some embodiments, container 10, as described herein, can be fabricated from materials suitable for food packaging products. In some embodiments, such materials include synthetic polymers such as thermoplastics, semi-rigid and rigid materials, elastomers, fabric and/or their composites.

In some embodiments, container 10 has a crystallinity from about 23% to about 32%. In some embodiments, a preform of container 10 can be heated and stretched to produce a container 10 having a crystallinity between about 10 and about 50%. In some embodiments, the preform of container 10 includes a molecular weight between about 120,000 g/mol and about 500,000 g/mol.

A finished PET blow-molded, container 10 is manufactured for use with a selected application, as described herein. In some embodiments, the selected application includes food, food preparation oils, viscous and/or beverage products.

In some embodiments, the present manufacturing method provides PET enhancements via improved material orientation with selective physical performance features, for example, improved top load performance and/or improved MVTR performance.

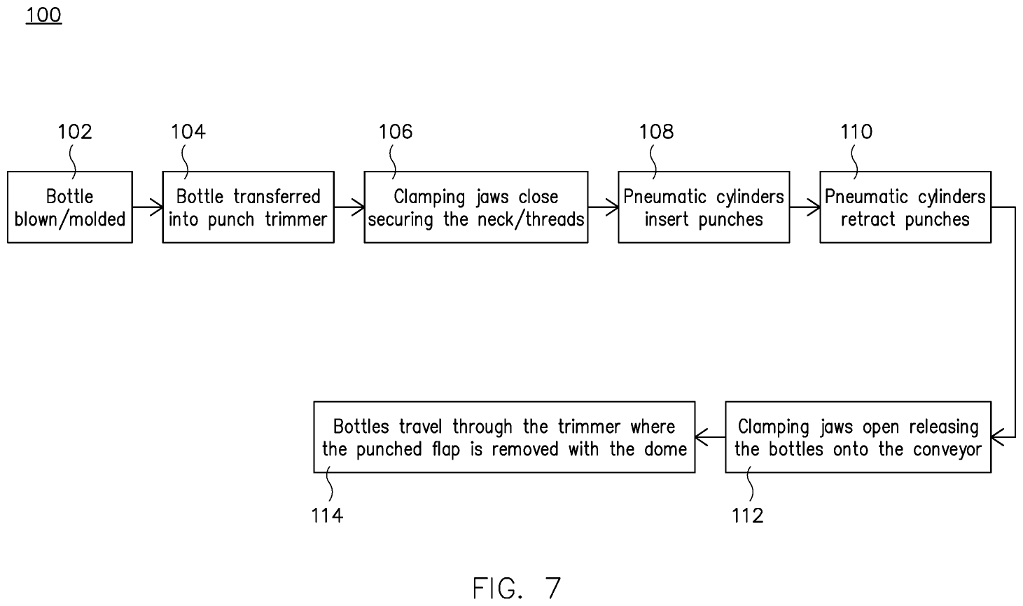

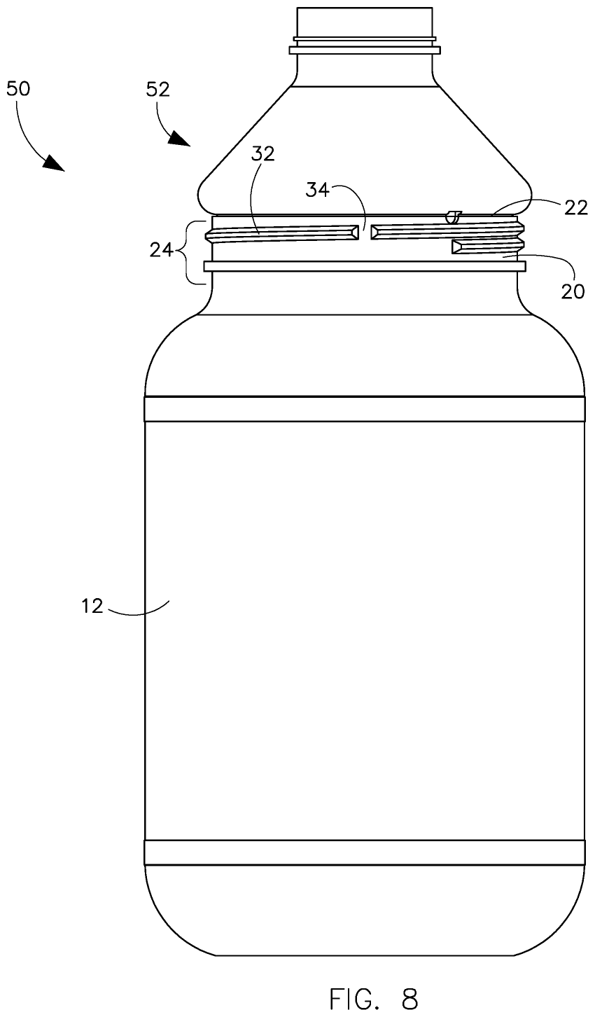

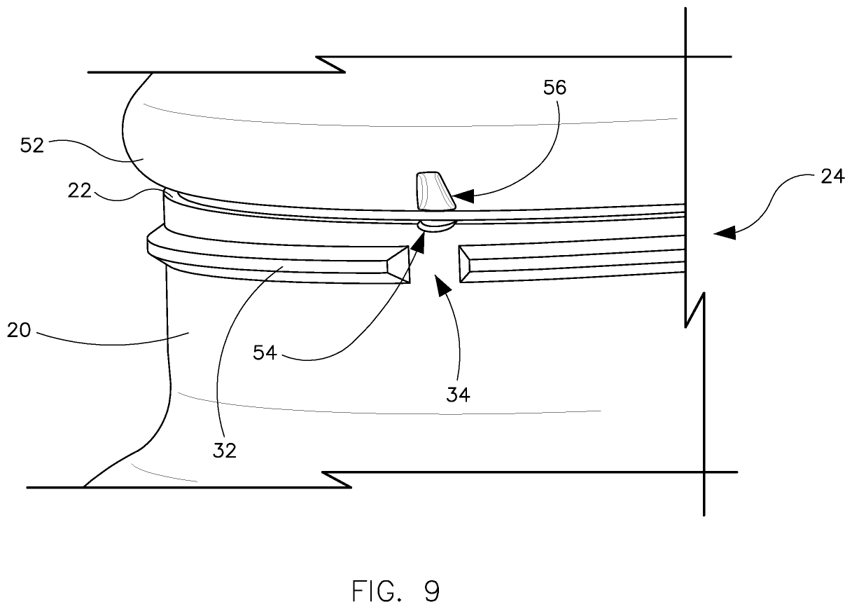

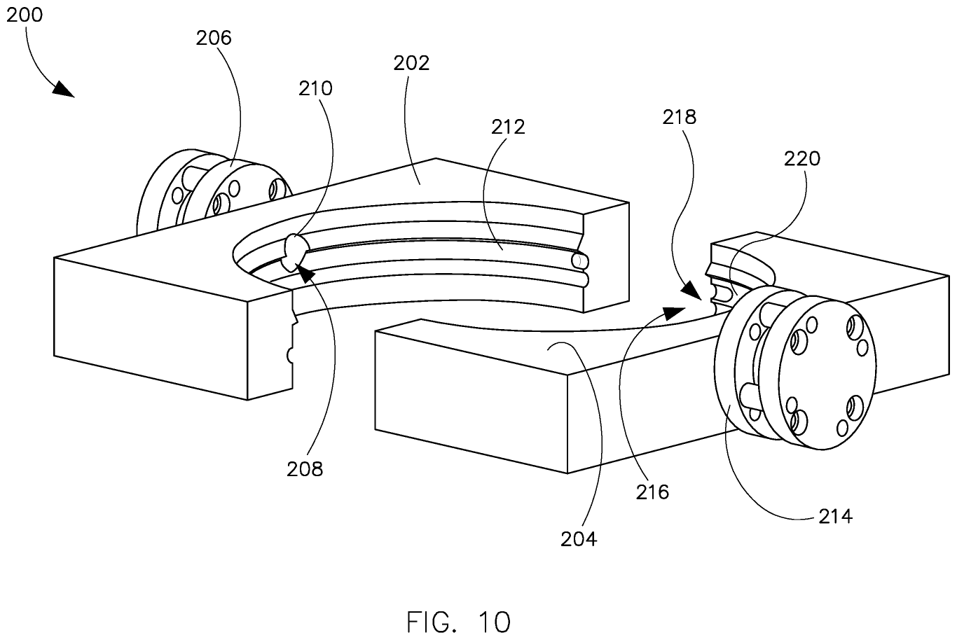

In some embodiments, a method for manufacturing container 10, as shown in FIGS. 7-10 is provided. During manufacturing 100, a container preform is blown/molded in a blow molder in a step 102, as shown in FIGS. 8 and 9. The container preform includes a selected configuration and is molded into an intermediate article, for example, an intermediate container 50 having neck 20, sealing surface 22, neck finish 24, thread 32 including gap 34, and a dome 52, as shown in FIG. 8. In some embodiments, the method includes an HDPE intermediate container 50 manufactured via an extruder instead of being molded from a container preform. Intermediate container 50 is transferred into a punch trimmer 200 (shown in FIG. 10) in a step 104.

Punch trimmer 200 is configured to form vent 30 within intermediate container 50 relative to a recess 54 that is pre-formed into the intermediate article via the mold. Punch trimmer 200 includes a clamping jaw 202 and a clamping jaw 204. Clamping jaws 202, 204 are configured for engagement with neck 20 and/or thread 32. Clamping jaw 202 includes pneumatic cylinders 206 that include a punch 208. An inner surface of clamping jaw 202 defines an opening 210. Punch 208 is configured for disposal and translation within opening 210, as described herein. The inner surface of clamping jaw 202 defines threaded portions 212 configured for engagement with neck 20 and/or thread 32. Clamping jaw 204 includes pneumatic cylinders 214 that include a punch 216. Pneumatic cylinders 214 are diametrically opposed to pneumatic cylinders 206. An inner surface of clamping jaw 204 defines an opening 218. Punch 216 is configured for disposal and translation within opening 218, as described herein. The inner surface of clamping jaw 204 defines threaded portions 220 configured for engagement with neck 20 and/or thread 32.

Clamping jaws 202, 204 are positioned in a closed orientation to secure neck 20 and/or thread 32 in a step 106. Pneumatic cylinders 206 and/or 214 insert punches 208 and/or 216 into intermediate container 50 in a step 108 to form vent 30. Vent 30 is disposed in sealing surface 22, as described herein. Punches 208 and/or 216 are configured to cut vent 30 in a flush configuration with sealing surface 22. Dome 52 includes a relief or recess 56 where vent 30 can be punched and/or cut out below recess 56 in sealing surface 22, as shown in FIG. 9. In some embodiments, vent 30 is disposed in sealing surface 22 and dome 52 simultaneously. In some embodiments, punches 208 and/or 216 are rapidly inserted into intermediate container 50. In some embodiments, punches 208 and/or 216 cut vent 30 vertically into dome 52 on one or more sides of recess 56. Punches 208 and/or 216 are inserted into the intermediate container 50 to produce a U-shaped cut vent 30. A top of the U-shaped cut vent 30 is left uncut and is creased/hinged inwardly (e.g., a punched flap/articulating element) by punches 208 and/or 216. The top of the U-shaped cut vent 30 translate into dome 52.

Punches 208, 216 are retracted via pneumatic cylinders 206, 214 from intermediate container 50 in a step 110. Punch trimmer 200 is retracted and clamping jaws 202, 204 are positioned in an open orientation to release intermediate container 50 and to position intermediate container 50 onto a conveyor (not shown) in a step 112. In some embodiments, clamping jaws 202, 204 are positioned in the open and closed orientation via a programmable logic controller (no shown). In some embodiments, the programmable logic controller receives inputs from a blow molder programmable logic controller and/or receives inputs from one or more sensor inputs. In some embodiments, the punching process is controlled by the programmable logic controller.

Intermediate container 50 travels through a trimmer (not shown) where a top of the U-shaped cut vent 30 that is hinged (e.g., punched flap/articulating element) and disposed with dome 52 are removed in a step 114. The end product of manufacturing 100 is the finished container 10, shown in FIG. 1-5.

In some embodiments, manufacturing 100 is configured for use with various types of plastic containers produced with a blown neck finish. In some embodiments, manufacturing 100 can be employed to produce various types of vent 30 configurations along a sealing surface of a blown finish container.

In some embodiments, a method for manufacturing container 10 is provided. In some embodiments, during manufacturing, a container preform is blown/molded in a blow molder. In some embodiments, vent 30 is molded into the preform without the additional step of a punch trimmer 200, as described herein. The container preform includes a selected configuration and is molded into an intermediate article (not shown) having neck 20, sealing surface 22, neck finish 24, vent 30, thread 32 including gap 34, and a dome 52. The intermediate container travels through a trimmer (not shown) where dome 52 is removed. The end product of manufacturing is the finished container 10, shown in FIG. 1-5.

In some embodiments, the method includes reusing dome 52 to produce other containers. In some embodiments, reusing dome 52 includes grinding, blending, drying and adding dome 52 and adding the ground, blended and dried material to a melt stream, wherein dome 52 does not contain additives.

In some embodiments, during manufacture, container 10 is filled with food and/or beverage products at a fill site utilizing automated fill equipment. In some embodiments, the food and/or beverage products are hot due to high temperatures in the fill and pasteurization of the products. Positive pressure is induced in all directions inside container 10 when container 10 is filled with the food and/or beverage products. In some embodiments, container 10 is capable of maintaining an initial shape at an elevated pressure of greater than 3 pounds per square inch (psi) and withstands a vacuum draw of greater than 3 In Hg during filling of container 10 with hot food and/or beverage products.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. A blow molded container comprising:
a neck including a sealing surface and a neck finish,
the sealing surface defining at least one vent.

2. A blow molded container as recited in claim 1, wherein the at least one vent is configured for passage of a pressurized gas.

3. A blow molded container as recited in claim 1, wherein the at least one vent includes a plurality of vents.

4. A blow molded container as recited in claim 1, wherein the sealing surface includes a circumferential lip extending from an opening of the neck and being configured to sealing engage a closure.

5. A blow molded container as recited in claim 4, wherein the at least one vent includes a plurality of vents disposed about the lip.

6. A blow molded container as recited in claim 1, wherein the neck finish includes at least one thread.

7. A blow molded container as recited in claim 1, wherein the neck finish includes a snap bead.

8. A blow molded container as recited in claim 1, wherein the neck finish includes a thread that is discontinuous.

9. A blow molded container as recited in claim 1, wherein the neck finish includes spaced apart portions.

10. A blow molded container comprising:
a neck including a circumferential lip extending from an opening of the neck and being configured to sealing engage a closure, the neck further including a neck finish having at least one gap; and
a body defining a volume and having a base,
the lip defining at least one vent aligned with the at least one gap in a configuration for passage of a gas from the volume.

11. A blow molded container as recited in claim 10, wherein the at least one vent includes a plurality of vents disposed about the lip.

12. A blow molded container as recited in claim 10, wherein the body defines a longitudinal axis and the at least one vent is axially aligned with the body.

13. A method for manufacturing a blow molded container, the method comprising the steps of:
blow molding a preform having a selected configuration into an intermediate article having a neck and a dome, the neck including a sealing surface having at least one recess and a neck finish;
cutting the sealing surface to define an articulating element including the at least one recess; and
trimming the intermediate article to remove the dome and the element in a configuration to form a finished container including the sealing surface having at least one vent.

14. A method as recited in claim 13, wherein the step of blow molding includes a mold having a sealing surface including at least one recess configured to form the at least one recess of the sealing surface of the intermediate article.

15. A method as recited in claim 14, wherein the step of blow molding includes the sealing surface having a plurality of recesses.

16. A method as recited in claim 14, wherein the step of blow molding includes the dome of the intermediate article having at least one recess.

17. A method as recited in claim 14, wherein the step of blow molding includes a mold having a dome including at least one recess configured to form the at least one recess of the dome of the intermediate article.

18. A method as recited in claim 14, wherein the step of cutting includes cutting the dome to define an articulating element including the at least one recess of the dome.

19. A method as recited in claim 18, wherein the step of cutting includes a punch configured to form the element of the sealing surface and the element of the dome simultaneously.

20. A method as recited in claim 19, wherein the punch includes clamping jaws configured to support the neck and diametrically opposed punch cylinders configured to form the elements.
